(19) United States
(12) Patent Application Publication
(10) Pub. No.: US 2012/0023446 A1
(43) Pub. Date: Jan. 26, 2012

(54) PRESENTATION OF A DIGITAL MAP

(76) Inventor: Tor Björn Minde, Gammelstad (SE)

(21) Appl. No.: 13/145,600

(22) PCT Filed: Jan. 30, 2009
(86) PCT No.: PCT/SE2009/050104

§ 371 Date: Jul. 21, 2011

(51) Int. Cl. G06F 3/048

(52) U.S. Cl. 715/810

(57) ABSTRACT

The invention relates to user access to data sets associated with a digital map via a user terminal. According to the invention the digital map together with data indicators associated with positions on the map and providing data sets are obtained. Here each data indicator is provided with at least one priority setting. A selection of data indicators is then made for the map when it is scaled for presentation via the user terminal and divided into sectors. Each sector comprises a number of neighbouring positions and is associated with a corresponding data indicator threshold defining how many data indicators that are allowed to be presented together with this sector. The selection involves selecting data indicators according to their priority settings and limited by the corresponding data indicator threshold for being presented with each sector. Then the scaled digital map is presented via the user terminal together with the selected data indicators.

### TECHNICAL FIELD

The invention relates to presenting of digital maps via user terminals. More particularly, the invention relates to a method, device and computer program product for user access to data sets associated with a digital map via a user terminal.

### BACKGROUND

It is known to present digital maps via user terminals such as via computer and cellular phone displays. It is then also known to present data indicators that indicate information that is of interest to a user together with such digital maps. WO 97/07467 does for instance describe a digital map with which icons are presented. Through clicking on an icon different data sets of a type associated with this icon are fetched and presented on the digital map at various corresponding positions associated with these data sets.

Presentation of images with a position is used in many applications like Flicr and Panoramia. A position on a digital map is here defined by longitude and latitude in WGS84. WGS84 is World Geodetic System 1984 used in GPS.

It is also known to apply a priority setting to data indicators and data sets. One well known priority setting method used to present web pages is the Google PageRank, which is for instance described by Sergey Brin and Lawrence Page (1998) in “The anatomy of a large-scale hypertextual Web search engine”. Proceedings of the seventh international conference on World Wide Web 7: 107-117. PageRank is a link analysis algorithm that assigns a numerical weighting to each element of a hyperlinked set of documents, such as the World Wide Web, with the purpose of “measuring” its relative importance within the set. The algorithm may be applied to any collection of entities with reciprocal quotations and references. The numerical weight that it assigns to any given element E is also called the PageRank of E and denoted by PR(E).

When presenting data indicators and data sets together with a digital map, there is a problem in that too many data indicators may be presented with the digital map. This problem usually persists even if the presentation is limited to data sets of a certain type. This situation may make it harder for a user of the user terminal to get any useful information. This problem, which may be serious when the user terminal includes a typical stationary computer screen or a laptop display, gets even more severe when the user terminal is a cellular phone, which has a display that is normally much smaller in size. This type of device may therefore not be able to present any useful information.

There is therefore a need for improvement in this field of technology.

### SUMMARY

The invention is therefore directed towards improving the user friendliness in relation to presenting of digital maps.

One object of the invention is thus to provide more user-friendly user access to data sets associated with a digital map via a user terminal.

This object is according to a first aspect of the invention achieved through a method for user access to data sets associated with a digital map via a user terminal. In the method the digital map together with data indicators associated with positions on it are obtained. Here the data indicators provide the data sets and the data indicators are all being provided with at least one priority setting. The digital map is scaled for presentation via the user terminal. It is also divided into sectors. Each sector comprises a number of neighbouring positions and is associated with a corresponding data indicator threshold that defines how many data indicators are allowed to be presented together with the sector. In the method there is furthermore performed a selection of the data indicators to be presented with the sectors. The selection is made according to the priority settings of the data indicators and limited by the data indicator thresholds. The scaled digital map is then presented via the user terminal together with the selected data indicators.

The object is according to a second aspect of the invention achieved through a device for user access to data sets associated with a digital map via a user terminal. The device includes at least one communication interface for communicating with a map providing device and a map presentation selection control unit. The map presentation selection control unit obtains, from the map providing device via the communication interface, the digital map together with data indicators associated with positions on this map. The data indicators providing the data sets are each being provided with at least one priority setting. When the map is scaled for presentation via the user terminal and divided into sectors, where each sector comprises a number of neighbouring positions and is associated with a corresponding data indicator threshold defining how many data indicators that are allowed to be presented together with this sector, the map presentation selection control unit selects data indicators to be presented with each sector of the scaled digital map according to their priority settings and limited by the corresponding data indicator threshold. Thereafter it presents the scaled digital map together with the selected data indicators via a user terminal data presenting unit.

The device may be a server with which the user terminal communicates for receiving the scaled digital map and corresponding data indicators. Alternatively the device may be the user terminal and then it would include a user input unit as well as the data presenting unit.

The above-mentioned object is according to a third aspect of the invention solved through a computer program product comprising computer program code. When the code runs on a device for user access to data sets associated with a digital map via a user terminal, it causes the device to perform a number of steps. First it obtains the digital map together with data indicators associated with positions on the digital map and providing such data sets. The data indicators are here each being provided with at least one priority setting. A selection is made when the map is scaled for presentation via the user terminal and divided into sectors, where each sector comprises a number of neighbouring positions and is associated with a corresponding data indicator threshold defining how many data indicators that are allowed to be presented together with this sector. The selection involves selecting data indicators to be presented with each sector of the scaled digital map according to their priority settings and limited by the corresponding data indicator threshold. Finally the scaled digital map is presented together with the selected data indicators via the user terminal.

The invention has many advantages. It provides a more user friendly presentation of data indicators with a digital map. It does so through organizing relevant data indicators and presenting them in a usable way. The invention makes it possible to present data associated with a geographical area depending on what is visible of the area on a map presented via the user terminal.

According to one variation of the invention at least one data indicator points at the location of a corresponding data set and based on the reception of a user selection of an associated data set via the corresponding data indicator this data set is fetched from the location at which the data indicator points. This variation has the advantage of allowing a user to easily obtain the data set if it is not a part of the data indicator.

According to another variation of the invention the data indicators have a type setting and the data indicators being presented are of a type that is associated with a type selection made by the user. One advantage of this variation is that only data indicators that are actually of interest to the user are presented.

At least one sector may according to a further variation be too large for being completely presented via the user terminal. Data indicators of this sector that are associated with positions outside of a presenting area of the user terminal are then provided as direction indicators presented at an edge of the presentation area. These data indicators then indicate the direction away from the presenting area. One advantage of this variation is that a limited sized presentation area can be used more efficiently.

According to a yet another variation, the obtained digital map may be centred around a reference position associated with the user terminal. The advantage of this is that a map may be obtained that is centred to a geographical area most likely to be of relevance to the user, namely the position associated with the user terminal itself.

According to yet some further variations, the size and shape of the sectors may be selected based on the scaling used and the size of an available presenting area of the user terminal. Here the sizes of the sectors may further be based on the number of covered data indicators. Both the size and shape of the sectors may also be selected for distributing data indicators to be presented evenly in relation to an indicated reference position. All these variations have the advantage of increasing the user-friendliness of the presentation depending on how data indicators are distributed.

According to another variation of the invention, a user selection of changing a first group of data indicators currently being presented in at least one sector is received, a second group of currently non-presented data indicators for each such sector and limited to the corresponding data indicator threshold is thereafter selected. This selection is then followed by presenting the second group of data indicators instead of the first group of data indicators. This has the advantage of allowing a user to view more data indicators in a sector, without diminishing the user-friendly way data indicators are presented.

According to yet another variation of the invention an indication that there are further non-presented data indicators associated with at least one presented sector of the scaled digital map is presented. The presenting of this further indicator may here be based on the number of remaining data indicators of the sector and their priorities. The indication may here also indicate a next high priority data indicator that is stopped from being presented by the corresponding data indicator threshold. All these measures have the advantage of informing a user that there are more data indicators of interest in a sector without diminishing the user-friendly way data indicators are presented.

According to another variation of the invention the priority setting is based on at least one prioritizing scheme in the group of PageRank, own interest scale and user rating.

According to some variants of the invention the data indicator thresholds may be the same in all presented sectors or individually set for the different sectors based on the distribution of priority settings in these sectors. These variants have the advantage of increasing the user-friendliness of the presentation depending on how data indicators are distributed.

The presenting of the data indicators may according to a further variant include presenting of their priority settings, which has the advantage of allowing a user to better inform him- or herself of the relevance of the data indicators.

Yet another variation involves weighing the priorities of the data indicators in order to obtain the priority settings. The weigh used for each data indicator can here be based on the distance between the user terminal and the position of the corresponding data indicator. This has the advantage of providing a more refined selection of data indicators that weighs in the possible physical effort needed by the user to reach a location associated with a data indicator.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The invention will now be described in more detail in relation to the enclosed drawings, in which:

FIG. 1 schematically shows a map server being directly connected to a map database and to a user terminal via a communication network,

FIG. 2 shows a simplified block schematic of the map server,

FIG. 3 schematically shows the contents of the map database including a digital map, a number of data indicators, positions on the digital map related to these indicators, their priority settings, and type indicators,

FIG. 4 shows a simplified block schematic of one user terminal according to a first embodiment of the invention, which is here also a device for user access to data sets,

FIG. 5 shows a flow chart of a number of method steps being performed in a method for user access to data sets according to the first embodiment of the invention,

FIG. 6 shows a digital map being presented via the user terminal with data indicators according to the principles of one variation of the invention,

FIG. 7 shows a digital map being presented via the user terminal with data indicators according to the principles of another variation of the invention, and

FIG. 8 schematically shows a computer program product according to an embodiment of the invention in the form of a CD ROM disc.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary detail.

The invention is generally directed towards presenting data indicators together with digital maps via user terminals. Here a data indicator is an indicator being associated with a position on the digital map. It may for instance visually indicate a position on the digital map. A data indicator may be a graphical symbol like an icon presented on or in relation to the digital map. The data indicator provides one or more data sets. A data set is here a data set that may be of interest to a user of the user terminal. The data set is thus here also associated with this position. This data set may be provided as the data indicator itself, for instance if it is an image, which may be a still or video image. However the data set may just as well be data provided at another location, typically on a server. In this case the data set may be a web page or a mobile application that is usable in certain areas. Also here it may of course also be a digital image. A data set may include data providing information that can be of interest to the user, such as information about various services like hair-dressers or stores, as well as indicating a point-of-interest, like a historically interesting site. As was mentioned above, the data indicator may be an icon. It may however be another symbol, which in some way provides an appropriate indication that enables a user to identify that a data set that may be of interest to him or her is linked to the associated position on the digital map.

The invention is more particularly directed toward presenting a limited number of data indicators associated with positions on the digital map in order to enhance the possibility for the user to easily discern between data indicators of various relevance to him or her.

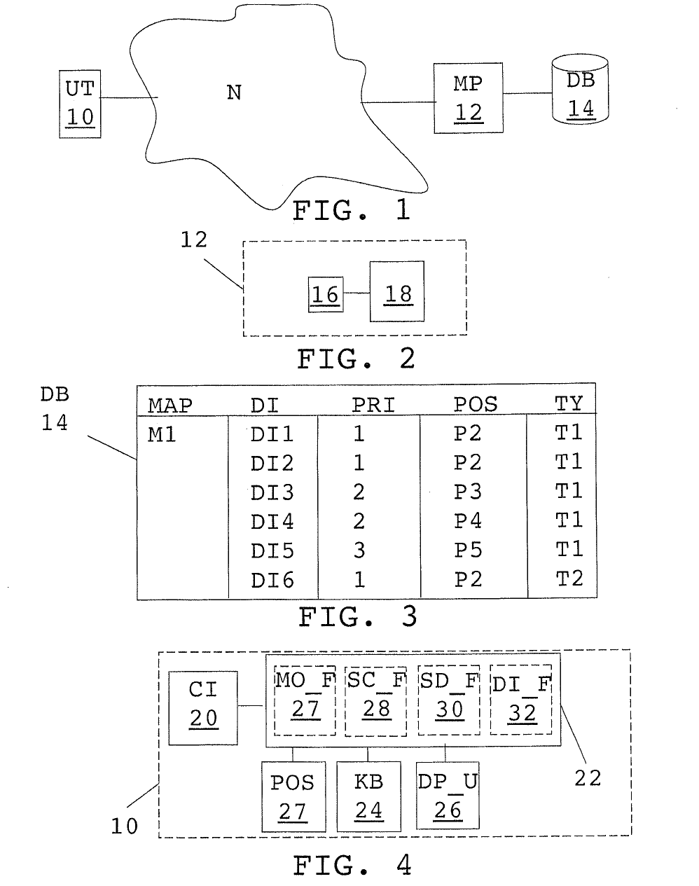

The invention will now be described in more detail in the non-limiting example context of a communication network N that may be a WAN (Wide Area Network). The network N is shown in FIG. 1. This network N may here be a cellular network such as an UMTS (Universal Mobile Telecommunications System) network or an LTE (Long Term Evolution) network. However it may also be a landline network. The invention is actually not limited to wide area networks, but may in fact be realized without the use of such networks. To the network N there is connected a user terminal 10, which in the present example is a cellular phone. A cellular phone is merely one example of a user terminal with which the invention may be used. Other types of user terminals are computers, like a PC (Personal Computer) and laptop and/or palmtop computers, and electric organizers. The user terminal 10 communicates with a map server 12, which in turn is connected to a map database 14.

In one variation of the invention to be described the user terminal 10 is a device for user access to a data set associated with a digital map. In other variations of the invention the map server 12 acts as such a device. In the first case the map server is a map providing device providing a map to the user terminal. In the second case the map database is a map providing device providing a map to the map server.

FIG. 2 schematically shows the content of the map server 12. The map server 12 includes a communication interface 16 to the network for communicating with other devices via the network as well as with the database 14. It also includes a server map handling unit 18, which in the example to be given later processes instructions received from the user terminal 10, fetches digital maps and data associated with digital maps from the map database 14 and returns the results to the user terminal 10.

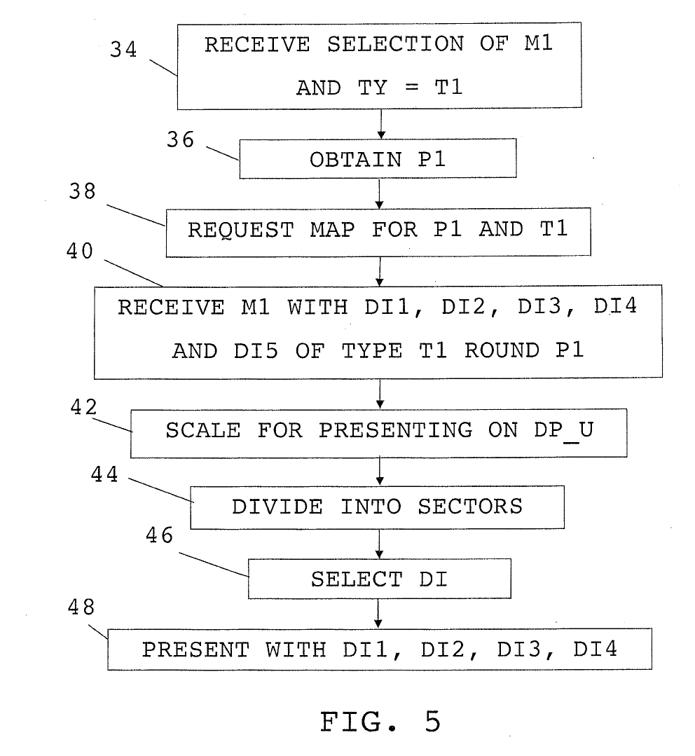

FIG. 3 schematically shows the content of the map database 14 in relation to the first embodiment of the invention. The database 14 includes one or more digital maps. Here there is only shown one digital map M1, in order to simplify the description of the invention. The digital map M1 has various positions, typically defined in the form of longitude and latitude. With the digital map M1 there are associated a number of data indicators DI. These data indicators DI are furthermore associated with various positions POS of the digital map M1. The data indicators DI are furthermore provided with one or more priority settings and in this example with only one priority setting PRI. The priority setting PRI is actually related to a data set that is linked to the data indicator. A priority setting is typically a setting according to one or more prioritizing principles for the corresponding data set, such as one in the group of Page Rank, own interest scale or user rating. Each data indicator in the present example furthermore has one or more data set type settings. However, it is possible to provide the invention without such data type settings. A type setting may be an indicator of the type of data provided in the corresponding data set. It may also be an indication of a type of service provided by an establishment being associated with the data set. It may indicate that the data set is associated with a store like a restaurant or a sports shop. It should here furthermore be realized that there may be more than one map database, one database containing the actual digital map and at least one other containing the data indicators with associated data (priority setting, position and type).

In FIG. 3 there is more particularly shown a first data indicator DI1 having a priority of 1 and being associated with a position P2 on the digital map M1 and being of type T1, a second data indicator DI2 also having a priority of 1, being associated with the position P2 on the digital map M1 and of type T1, a third data indicator DI3 having a priority of 2, being associated with a position P3 on the digital map and also of the type T1, a fourth data indicator DI4 having a priority of 2, being associated with a position P4 on the digital map and also of the type T1, a fifth data indicator DI5 having a priority of 3, being associated with a position P5 on the digital map and being of type T1 and finally a sixth data indicator DI6 also having the priority of 1 and being associated with the position P2 on the digital map but being of type T1. It should here be realized that there may be many more data indicators having a wide range of priorities and types being associated with various positions on the digital map. The number has here been limited to six merely in order to simplify the description of the invention.

FIG. 4 schematically shows a block schematic of the user terminal 10 according to a first embodiment of the invention. The user terminal 10 includes a communication interface CI 20 for communicating with the map server via the network. The communication interface 20 is connected to a user terminal map handling unit, which in turn is connected to a user input unit 24, here in the form of a keyboard KB and to a data presenting unit 26 here in the form of a display unit DP_U 26. The map handling unit is in the embodiment shown in FIG. 4 a map presentation selection control unit 22 and implements a map obtaining function MO_F 27, a scaling function SC_F 28, a sector dividing function SD_F 30 and a data indicator selection function DI_F 32. The user terminal may be e.g. a laptop or a mobile phone.

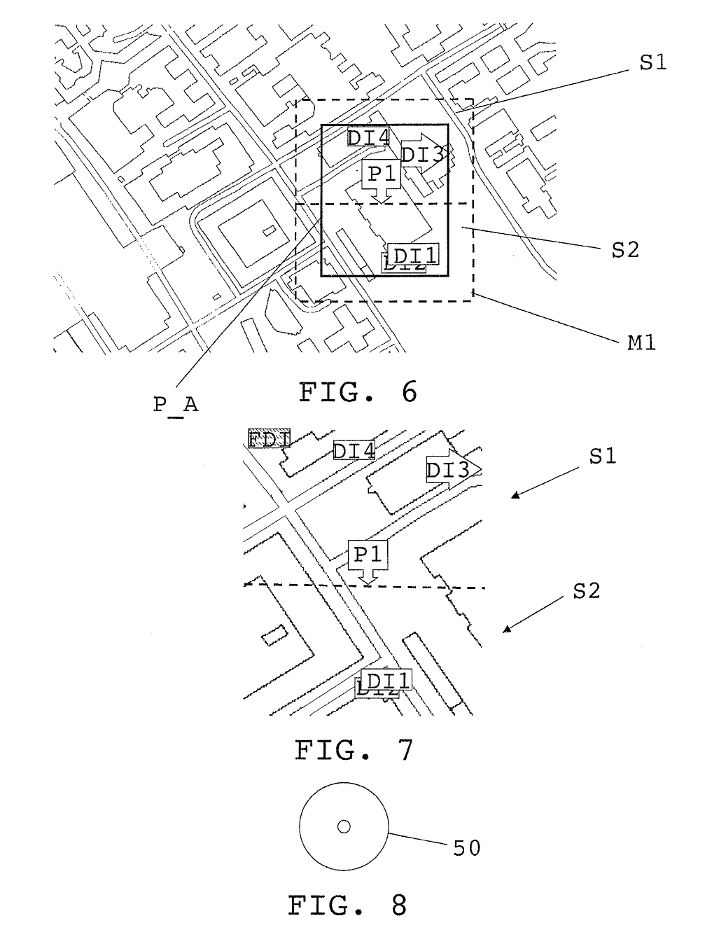

Now the functioning of the invention will be described in more detail with reference being made to the previously described FIGS. 1 - 4 as well as to FIG. 5, which shows a flow chart of a number of method steps being performed in a method for user access to data sets according to the first embodiment of the 30 invention, and to FIG. 6, which shows a digital map being presented via the user terminal with data indicators according to the principles of a first variation of the invention.

With digital maps it is today possible to provide a user of a user terminal with a great deal of information regarding various positions on the digital map. This opens up great opportunities for a user to find interesting information and useful data regarding map positions as well as to locate data providing such information or other functionality that is of interest to him or her. However, there is also a negative aspect to this wealth of information. When there is such a wealth of information it may actually be very hard for the user to find and locate the positions associated with data of interest. It may get crowded by indicators associated with irrelevant data. There is therefore a need to organize and structure map and map related data like data indicators so that the user can more easily discern positions on the digital map with which information of interest to him or her from a great many uninteresting such positions. The user terminal used for presenting such a digital map may furthermore be a cellular phone or an organizer. Since these are normally small in size, this also means that the area on which the digital map is presented, here named presenting area, is small, which makes the problem even more severe.

The invention is aimed at improving this situation.

The user terminal 10 is in this first embodiment shown in FIG. 4 a device for user access to data sets associated with a digital map. It thus provides a digital map together with data indicators for a user of the user terminal.

In order to do this the user terminal 10 provides a map presentation application via the map presentation selection control unit 22. This is an application that the user of the terminal may access via the keyboard 24. In this application the user may obtain a digital map M1 on which data indicators DI providing data sets for the user are presented. In the presently described embodiment this presenting may be combined with a search regarding the above mentioned type. The search regarding type may here be a search for such diverse things as restaurants or other types of services, communication technology companies, digital images and mobile phone applications.

The exemplifying method may therefore start through the map presentation selection control unit 22 receiving a selection of a digital map M1 and a data set type TY, step 34. In the present example the user has selected a type T1, which may thus be restaurants. This user selection is here received by the map presentation selection control unit 22 via the keyboard 24. The map presentation selection control unit 22 may then optionally obtain a reference position P1 for the digital map, typically a position that is a central position of the digital map when being presented via the display unit 26 of the user terminal 10. This reference position P1 may be the position of the user, which would then normally coincide with the position of the user terminal 10. The position may therefore be associated with the position of the user terminal. Such a position may be obtained through the use of a positioning unit like a GPS unit or through a positioning service like a network-based positioning service such as MPS or cell-ID. The reference position P1 may also be obtained through the user indicating the position directly, for instance through suitable entries via the keyboard 24. He or she may for example enter a street address from which a position may be gathered. In the present example the map presentation selection control unit 22 therefore obtains the reference position P1, step 36. It should here be noted that the digital map may be centred around another position than the position of the user and the user terminal.

The selections of digital map M1, data set type T1 as well as reference position P1 are here received by the map obtaining function 27 of the map presentation selection control unit 22, which goes on and sends a request to receive a digital map for the position P1 with data set type TY set to T1 to the map server 12 via the communication interface 20, step 38. In one variation of the invention that is all that is sent. In some other variations it is possible that also indications about the geographical area the digital map is to cover is sent, possibly together with an indication of the size of a presenting area, which may be the display area of the display unit 26. This may be done through the user terminal 10 informing the map server 12 about which brand and model it is. The map server 12 may here have or access data regarding display unit sizes for various user terminal brands and models. It should here be realized that it is possible that the type information is omitted as well

The map handling unit 18 of the map server 12 receives this request via the network N and the communication interface 16 and fetches the digital map M1 from the map database 14. It is possible that the digital map M1 is in fact very large and that only a portion of it surrounding the reference position P1 is fetched. However, in the following description there will, for the sake of simplicity, be no distinction made between the whole or parts of such a map. Both will be denoted map M1.

In case no presenting or map coverage area indications are sent, then the map server 12 selects a digital map having a default map coverage area, i.e. covering a range of default positions, and centred around the reference position P1. If such indications have been received, then the map server 12 obtains a digital map having a coverage area that corresponds to the indicated coverage area and if a presenting area indication is received then it sends a digital map covering an area adjusted in relation to the presenting area and centred around the reference position P1. Here it is possible that a reference position is deduced from the indicated coverage area. It also fetches the data indicators DI that have positions within the map coverage area and here also only those having the selected type. Alternatively the selection of data indicator based on type may be performed later by the map presentation selection control unit 22 of the user terminal 10. This fetching is performed from the map database 14 by the map handling unit 18. As was mentioned earlier this further data may thus be provided in a separate database.

In the present example the data indicators DI1, DI2 DI3, DI4 and DI5 are all associated with positions P2, P3, P4 and P5, respectively, that lie within the coverage area. They are also of the correct type T1. However, the sixth data indicator DI6 is of another type and hence it is not selected even though it is associated with a position P2 that lies within the map coverage area. These selected data indicators DI1, DI2, DI3, DI4 and DI5 and the associated data (priority setting, position and possibly also type) are then sent by the map handling unit 18 of the map server 12 to the user terminal 10 via communication interface 16.

The digital map M1 being centred around the reference position P1 together with the data indicators DI1, DI2, DI3, DI4 and DI5 of type T1 is received by the scaling function 28 of the map presentation selection control unit 22 via the communication interface 20, step 40. In this way the map presentation selection control unit 22 thus obtains the above-mentioned data through receiving it. The scaling function 28 then goes on and scales the digital map M1 for being presented on the display unit 26, step 42. More particularly, it scales the map for being presented in the presenting area P_A of the display unit 26. As is evident from what has been described above the scaling may as an alternative be performed by the map server 12 if it has received the proper presenting area indications. The digital map may here be scaled so that it covers the whole or actually more than the whole presenting area P_A. The presenting area P_A may be the whole of the display area or a part of the display area of the display unit 26. The sector dividing function 30 then divides the digital map M1 into sectors, step 44. Each sector then comprises a number of neighbouring positions. Here it should be known that as an alternative also this sector diving can be performed by the map server 12. The size and shape of the sectors may here also be selected based on the scaling used and the size of the available presenting area P_A of the user terminal 10.

According to one very simple sector division scheme shown in FIG. 6, the digital map is divided in half horizontally so that there are only two sectors, a first upper sector S1 and a second lower sector S2 with the reference position P1 provided centrally on the border between these sectors S1 and S2. As can be seen in FIG. 6 the digital map M1 is furthermore rectangular in shape and covers a larger area than the presenting area P_A. This means that at least one, and here both sectors S1 and S2, is too large for being completely presented via the user terminal 10.

As this has been done, the data indicator selecting function 32 selects the data indicators that are to be presented with the digital map M1 and more particularly the data indicators to be presented with each sector.

For this reason it applies a corresponding data indicator threshold. In this embodiment the same threshold is used for all sectors. In the present example both sectors thus use the same threshold, which is furthermore set to two. This means that such a threshold defines how many data indicators that are allowed to be presented together with a sector of the digital map and here presented in such a sector. It should here be realized that in some variations of the invention these thresholds may differ from each other. They may thus be individually set for the different sectors, for instance based on the distribution of priority settings in these sectors.

The data indicator selecting function 32 here selects the data indicators according to their priority settings and limited by the corresponding data indicator threshold for being presented with the corresponding sector. This means that here it selects the data indicators that have the highest priorities in a number that does not exceed the data indicator threshold. In this example, this means that it selects the two data indicators having the highest priorities in each sector. In this case this furthermore means the in the second sector S2 the first and the second data indicators DI1 and DI2 are selected, while in the first sector S1 the third and the fourth data indicators DI3 and DI4 are selected. The fifth data indicator DI5 has a position that lies within the first sector S1. However, since it has a lower priority than the third and the fourth data indicators DI3 and DI4 and the threshold has been reached, it is not selected. It is thus clear that the data indicator selecting function 32 selects data indicators according to priority settings and limited by data indicator thresholds, step 46.

When this has been done the scaled and sectored digital map is forwarded from the data indicator selecting function 32 to the display unit 26 which presents it on a dedicated presenting area P_A with the selected data indicators DI1, DI2, DI3 and DI4, step 48. Since the user in this embodiment previously made a type selection, the data indicators being presented are here all associated with this type selection. Here one of the data indicators of the first section S1, the third data indicator DI3, is associated with a position that is outside of the presenting area P_A. This position associated with the third data indicator DI3 may be indicated through using a directionally shaped data indicator, i.e. may be provided as a direction indicator, here an arrow, that is provided at an edge of the presenting area P_A and indicating the direction from the presenting area P_A to this position. The other data indicators are here shown as boxes. The first and second data indicators DI1 and DI2 are both associated with the same position P2, they are therefore shown as stacked onto each other in FIG. 6.

If the user then selects one of the data indicators he or she may then fetch the corresponding data set, which in the present example is a web page. This means that a data indicator may point at the location of a corresponding data set. Therefore the map presentation selection control unit may receive a user selection of an associated data set via the corresponding data indicator and then fetch this data set from the location at which the data indicator points. In order to perform this the data indicators may be arranged to invoke corresponding URLs (Uniform Resource Locators) when being selected. Selection may be performed through clicking on the data indicator. Typically a data set provided in an area of a server associated with this URL will then be fetched. The data set may for instance be a web page of a restaurant of the position or an application. This server from which the data set is fetched is normally a different server than the map server. In case the data set is an image the data indicator may be the image and thus it may already be presented.

It should here be realized that in some variations of the invention it is possible to zoom and pan the digital map M1. In this case it is possible that an instruction to this effect is sent to the map server 12, which in the case of a panning selects a corresponding map coverage area of the same size as before in a panning direction and then selects the data indicators in this area the fulfil the search criterion. In the case of a zooming, the map coverage area is changed in correspondence to the degree and direction of the zooming. A new map centred around the reference position and having a different scale and a different preciseness in specifying positions is then obtained. The preciseness of the positions associated with the data indicators are furthermore also changed for corresponding to the position preciseness in the new map. As an example a first data indicator has a position 59.4042 longitude and 17.9509 latitude and a second data indicator has a position 59.4027 longitude and 17.9499 latitude for at a certain zoom level, where they are presented distinctly separated from each other. If then the digital map is zoomed out, the preciseness in the specified position is changed, and here diminished. Then also the preciseness of the position associated with the data indicators are changed in a corresponding fashion. The position of the first data indicator may therefore be set as having 59.40 longitude and 17.95 latitude, while the position of the second data indicator may then also be set as 59.40 longitude and 17.95 latitude, i.e. they will be indicated as having the same position. As an alternative it is possible that positions associated with the data indicators in the map database are provided with different degrees of preciseness, one for every possible zoom level.

It may furthermore be possible for the user to change data indicator thresholds, for instance when performing zooming or in case he or she finds the number of data indicators being presented as being too few or too many. It may of course also be possible to enter a new search term in order to obtain new data indicators.

There are several further variations that may be made of the invention.

In the above described embodiment, changes were made in the presentation of the map with data indicators based on user inputs. It is, according to a variation of the invention, possible that a user may be less active when using the map presenting application, i.e. that the application is more automatic in nature. The map presentation selection control unit may here be arranged to continuously look for data indicators around the present position of the user. This automatic local map browsing for data indicators, for instance related to web-pages, services and pictures, is then made in relation to this continuously received varying reference position, which may be the position of the user terminal. This position may be a position received from a positioning unit, like a GPS unit in the user terminal. The positioning may also be provided through a network-based positioning service like MPS or cell-ID. The map presentation selection control unit may then send requests, repeatedly at given position intervals or time intervals, for data indicators and map around the current position.

The way the digital map was divided into sectors can be varied according to various schemes. The reason for providing different sector dividing schemes is to increase intelligibility of the presentation of data indicators. This intelligibility is dependent on the distribution of the data indicators with relevant priority settings on the digital map. This means that in one situation one type of sector dividing scheme may be appropriate and in another situation another type of sector dividing scheme may be preferred.

Three general examples of sector dividing schemes will be given here: rectangular sector division, pie sliced sector division and circular belt sector division. As mentioned earlier the sectored digital map can be larger than the presenting area, which means that it is not limited in shape to the shape of this presenting area. This also enables presentation of data indicators just outside the visible presenting area.

With rectangular sectors it is possible to divide the digital map into evenly distributed and sized rectangular sectors in a grid like fashion. This may be of interest when the data indicators are evenly distributed over the whole of the digital map. The size and the shape of the sectors may thus here be selected for distributing data indicators to be presented evenly in relation to the reference position. As mentioned earlier the digital map may coincide in size with the presenting area or be larger than the presenting area. In any case the presenting area may be provided centrally in the digital map or slightly shifted from the centre of the map, all depending on the data indicator distribution. With rectangular sections it is furthermore possible to divide the digital map into four even sized sectors, with two provided in the upper half of the presenting area and two covering the lower half. It is also possible with six sectors, with three covering the upper half of the presenting area and three the lower half. In case it is of interest to have one sector that is provided centrally around the reference position then nine equal sized sectors may be provided, with three covering an upper section of the presenting area, three covering a middle section of the presenting area and three covering a lower section of the presenting area. A central sector that assists in covering the middle section would then be centered around the reference position. Here it is also possible to provide different sector sizes. The sectors covering the middle section may for instance be smaller or larger than the sectors covering the upper and lower sections, while sectors that cover upper and lower section may all have the same size. It is also possible to provide the central sector of a different size, while the sectors covering the upper and lower sections of the presenting area are evenly sized. These were just a few examples of rectangular section forming.

The pie sliced sections may be provided as pie slices of a rectangular, circular or even elliptical cake shaped map. Here the slices all have corners in the centre of the map at the reference position, from where they extend radially. This type of section forming is of interest when the data indicators that are presented are distributed evenly in the different directions away from the reference position. Here it is possible to use any reasonable number of sectors from three and upwards. It is for instance possible with four or nine pie slices. If the coverage area of the digital map is to coincide with the presenting area, it is normally necessary to have a rectangular map.

The circular belt sectors are of interest to use when the data indicators are evenly distributed regarding distance from the central point. There is here a circular central section centered round the central point, the reference position, and having a certain radius. This central section is then surrounded by one or more ring shaped sectors that each may have a thickness equal to the radius of the ring. This provides sectors covering various distances from the central point. The thicknesses of the rings may of course be varied. If the digital map is to coincide in size with a rectangular presenting area, some rings will not be complete but “cut off” by the edges of the presenting area.

It is also possible to combine different sectoring methods, for example pie slice sector forming and circular belt sector forming. Also other sector shapes are feasible. The sectors can furthermore be sized according to the data indicator distribution where an area of the map having many data indicators may include more small sectors, while an area of the map with few data indicators have a few larger sectors. The size of a sector may thus be based on the number of data indicators covered by this sector.

In the present example the data indicator threshold limits the number of data indicators to a maximum number that can be presented in a sector. It is as an alternative also possible to have a threshold or maximum value for the total number of presented data indicators. This total number may in further variations of the invention be changed by the user interactively to enable him or her to see more results if needed. The user can also be enabled to toggle to the next number of prioritized data indicators, i.e. to those that could not be presented because of the data indicator threshold.

The number of data indicators being presented in each sector may be determined in various ways. The one already described was to evenly present a maximum number of data indicators in each sector. The data indicator threshold was furthermore the same in all the presented sectors. Another way is to present a minimum number of data indicators in each sector and then show the highest ranked data indicators that are left to present. This situation is schematically shown in FIG. 7, showing an enlarged version of FIG. 6. Here a further data indicator FDI, shown as a hatched box, is presented. This further indicator FDI is as an example provided in the first sector S1 and indicates that there are further non-presented data indicators in the sector that are of interest, i.e. have high priorities. This normally involves the next high priority data indicator that has been stopped from being presented by the applying of the data indicator threshold. The determination that there are such further data indicators of interest is here made based on the number of remaining data indicators of the sector and their priorities. One or more of these may then be presented through for instance clicking on this further data indicator FDI. It is in this way possible for the user to change a first group of data indicators currently being presented in a sector, here the third and fourth data indicators DI3 and DI4 of high priority, into a second group of currently non-presented data indicators, here only the fifth data indicator DI5, while applying the limitation of the data indicator threshold.

Other ways are also possible like determining the number of data indicators in each sector depending on the corresponding priority setting. This means that data indicators thresholds are individually set for the different sectors based on the distribution of priority settings in these sectors.

The size, shape and the graphical representation of the data indicators might be changed depending on how high a priority they have in order to signal their relevancy to the user. This can thus be used for presenting their priority settings. In this respect higher ranked data indicators may be larger than lower ranked data indicators. The shapes may also be used in this respect. Another way to indicate rank is through having various colours or various degrees of transparency. Here lower ranked data indicators may be more transparent than higher ranked data indicators.

The prioritizing was above described using PageRank. However, it is possible to use other prioritizing schemes like a descriptiveness score for a picture, which is an own interest scale, and a popularity score, which is a user rating.

These may furthermore be combined, using an appropriate weighting function.

Another way to weigh a priority of the data indicator is to use the distance between the reference position and the position associated with the data indicator. This may be used so that the greater the distance is the lower the priority gets through the weighting. This means that the priorities of the data indicators are weighed for obtaining the priority settings. The weigh used for each data indicator is in this variation then based on the distance between the user terminal and the position of the corresponding data indicator.

One way in which this weighing may be implemented is through providing a modified priority according to:

PRI′=W(d)*PRI

The modified priority PRI′ is determined as the non-weighed priority PRI multiplied by a weighting function W(d) based on distance d. The function may here have a dependence based on the squared distance. It may furthermore have an inverse dependence of the squared distance.

The weighting function may then be implemented as:

W(d)=100/(100+9d²)

Above there were described a number of different measures intended to simplify for a user to locate data sets that are of interest to him or her in relation to a digital map.

As was described above the map presentation selection control unit was provided in the map handling unit of the user terminal. However it is also possible that it is provided in the map handling unit of the map server, which map server then acts as the device for user access to data sets. The server would then receive position data together with possible presenting size data and type selection data and then perform scaling, sector division and data indicator selection. The digital map with these data indicators would then be sent to the user terminal, where presentation is performed.

The map presentation selection control unit may with advantage be provided in the form of a processor with associated program memory including computer program code for performing the functionality of the presentation selection control unit. It should be realized that this unit may also be provided in the form of hardware, like for instance in the form of an ASIC circuit. The computer program code may also be provided on a data carrier, like a CD ROM disc or a memory stick, which will implement the function of the map presentation selection control unit when being loaded into a server or user terminal. One such computer program product in the form of a CD ROM disc is schematically shown in FIG. 8.

The invention has many advantages. It provides a more user friendly presentation of data indicators with a digital map than before. It does so through organizing relevant data indicators at and around a reference position and presenting them in a structured and usable way. The invention presents data of a geographical area depending on what is visible of the area on a map presented via the user terminal. The invention can also take positions provided just outside the visible area into account.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the invention is only to be limited by the following claims.

1. A method for user access to data sets associated with a digital map via a user terminal, the method comprising the steps of:
obtaining the digital map together with data indicators associated with positions on said digital map and providing such data sets, said data indicators each being provided with at least one priority setting, wherein the priority setting is based on at least one prioritizing scheme in the group of PageRank, own interest scale and user rating and is weighed based on a distance between the user terminal and the position of the corresponding data indicator;
selecting data indicators for the digital map when scaled for presentation via the user terminal and divided into sectors, where each sector comprises a number of neighbouring positions and is associated with a corresponding data indicator threshold defining how many data indicators that are allowed to be presented together with this sector, said data indicators being selected according to their priority settings and limited by the corresponding data indicator threshold for being presented with each sector: and
providing said scaled digital map together with the selected data indicators for presenting via the user terminal.

2. The method according to claim 1, wherein at least one data indicator points at the location of a corresponding data set, the method further comprising the step of
receiving a user selection of an associated data set via the corresponding data indicator; and
fetching said data set from the location at which the data indicator points.

3. The method according to claim 1, wherein said data indicators have a type setting and the data indicators being provided are furthermore of a type associated with a type selection made by the user.

4. The method according to claim 1, wherein at least one sector is too large for being completely presented via the user terminal and data indicators of this sector associated with positions outside of a presenting area of the user terminal are provided as direction indicators for presenting at an edge of the presentation area and indicating the direction away from the presenting area.

5. The method according to claim 1, wherein the obtained digital map is centred around a reference position associated with the user terminal.

6. The method according to claim 1, wherein size and shape of the sectors are selected based on the scaling used and the size of an available presenting area of the user terminal.

7. The method according to claim 6, wherein the sizes of the sectors are based on the number of covered data indicators.

8. The method according to claim 7, wherein the size and shape of the sectors are selected for distributing data indicators to be presented evenly in relation to an indicated reference position.

9. The method according to claim 1, further comprising; receiving a user selection of changing a first group of data indicators currently being presented in at least one sector;
selecting a second group of currently non-presented data indicators for each such sector and limited to the corresponding data indicator threshold; and
providing the second group of data indicators instead of the first group of data indicators.

10. The method according to claim 1, further comprising providing, for at least one presented sector of the scaled digital map, an indication that there are further non-presented data indicators associated with this sector based on the number of remaining data indicators of the sector and their priorities.

11. The method according to claim 10, wherein said indication indicates a next high priority data indicator that is stopped from being presented by the corresponding data indicator threshold.

12. The method according to claim 1, wherein the data indicator threshold is the same in all presented sectors.

13. The method according to claim 1, wherein the data indicator thresholds are individually set for the different sectors based on the distribution of priority settings in these sectors.

14. The method according to claim 1, wherein the providing of the data indicators includes presenting providing of their priority settings.

15. A device for user access to data sets associated with a digital map via a user terminal, the device comprising:
at least one communication interface configured to communicate with a map providing device; and
a map presentation selection control unit configured to obtain, from the map providing device via the communication interface, the digital map together with data indicators associated with positions on said digital map and providing such data sets, said data indicators each being provided with at least one priority setting, wherein the priority setting is based on at least one prioritizing scheme in the group of PageRank, own interest scale and user rating and is weighed based on a distance between the user terminal and the position of the corresponding data indicator;
the map presentation selection control unit further configured to select data indicators for the digital map when scaled for presentation via the user terminal and divided into sectors, where each sector comprises a number of neighbouring positions and is associated with a corresponding data indicator threshold defining how many data indicators that are allowed to be presented together with this sector, said data indicators being selected to be presented with each sector of the scaled digital map according to their priority settings and limited by the corresponding data indicator threshold; and
the map presentation selection control unit further configured to provide said scaled digital map together with the selected data indicators to a user terminal data presenting unit.

16. The device according to claim 15, wherein the device comprises a server with which the user terminal communicates for receiving said scaled digital map and corresponding data indicators.

17. The device according to claim 15, wherein the device comprises the user terminal and includes a user input unit and said data presenting unit.

18. A computer program product comprising a non-transitory computer-readable storage medium having computer program code embodied therein which when run on a device for user access to data sets associated with a digital map via a user terminal, causes said device to:
obtain the digital map together with data indicators associated with positions on said digital map and providing such data sets, said data indicators each being provided with at least one priority setting, wherein the priority setting is based on at least one prioritizing scheme in the group of PageRank, own interest scale and user rating and is weighed based on a distance between the user terminal and the position of the corresponding data indicator;
select data indicators for the digital map when scaled for presentation via the user terminal and divided into sectors, where each sector comprises a number of neighbouring positions and is associated with a corresponding data indicator threshold defining how many data indicators that are allowed to be presented together with this sector, said data indicators being selected to be presented with each sector of the scaled digital map according to their priority settings and limited by the corresponding data indicator threshold; and
provide said scaled digital map together with the selected data indicators for presenting via the user terminal.

19. The computer program product according to claim 18 wherein the device comprises a server with which the user terminal communicates for receiving said scaled digital map and corresponding data indicators.

20. The computer program product according to claim 18 wherein the device comprises the user terminal and includes a user input unit and said computer program product.
